(19) United States
(12) Patent Application Publication
(10) Pub. No.: US 2025/0102298 A1
(43) Pub. Date: Mar. 27, 2025

(54) A DEVICE FOR INDICATING ORIENTATION OF AN OBJECT

(71) Applicant: Tilak SRINIVASAN, Bangalore, Karnataka (IN)

(72) Inventor: Tilak SRINIVASAN, Bangalore, Karnataka (IN)

(21) Appl. No.: 18/722,916

(22) PCT Filed: Jan. 11, 2023
(86) PCT No.: PCT/IB2023/050246

§ 371 Date: Jun. 21, 2024

(30) Foreign Application Priority Data
Jan. 11, 2022 (IN) 202241001432

(51) Int. Cl. G01C 9/02

(52) U.S. Cl. CPC G01C 9/02

(57) ABSTRACT

Present disclosure discloses a device for indicating orientation of an object is disclosed. The device includes a housing mountable on the object. The housing includes a first light source disposed on a first face of the housing and a second light source disposed on a second face of the housing. Further, the housing includes a first screen disposed on a third face of the housing, opposite to the first light source and a second screen disposed on a fourth face of the housing opposite to the second light source. Further, the device includes a hollow spherical member disposed within the housing and a solid sphere provided within the hollow spherical member. The solid sphere is configured to displace within the hollow spherical member pointing towards gravity, the solid sphere is adapted to cast a shadow on the first screen and the second screen based on light illuminated from the first light source and the second light source, to indicate orientation of the object.

### RELATED APPLICATIONS

The instant application is a 35 U.S.C. § 371 filing of International Patent Application No. PCT/IB2023/050246, filed Jan. 11, 2023, which claims priority to Indian Patent Application No. 202241001431, filed Jan. 11, 2022, the entire contents of which are incorporated herein by reference for all purposes.

### TECHNICAL FIELD

Present disclosure relates in general to a device for determining orientation of an object. Particularly, but not exclusively the present disclosure relates to a device for determining the orientation of the object about pitch, roll and yaw axes of the object.

### BACKGROUND OF THE DISCLOSURE

Determining orientation of an object may be useful in numerous applications. One such example is an airborne object such as an airplane or a helicopter, where the orientation of the airborne object is used to aid in determining orientation of the object and as well as aid in navigation of the object from its current location to a desired location, Generally, in order to describe a particular orientation or position of a rigid object in a 3-dimensional medium, three parameters along the X-axis, Y-axis and Z-axis are considered.

Conventionally, Euler angles are used to represent both the position and orientation of the rigid body. A local co-ordinate system having the following axes denoted by X, Y and Z which constitute the axes of frame and another co-ordinate system X, Y and Z which constitute the axes of the rotated frame. By using these co-ordinates both position and orientation of the rigid body can be determined, wherein, the reference orientation can be imagined to be a first orientation from which the frame virtually rotates to reach its actual orientation.

Myriad of devices such as gyroscopes, gimbal etc., are used in moving vehicles and aircrafts to determine the pitch, roll and yaw axes which play a key role in determining the orientation and positioning the moving vehicle/aircraft. A gyroscope works on the principle of angular momentum which basically is the amount of rotation an object has, taking into account its mass and shape. In simple words it is the vector quantity that represents the product of a body's rotational inertia and rotational velocity about a particular axis. However, the gyroscopes and gimbals may include multiple moving parts, which require frequent calibration for exhibiting accurate values. Also, the existing systems or arrangements may include more number of parts, which makes the system bulky and involves complex operational features.

Conventionally, available orientation detection devices may include light sources and sensors which are, generally, positioned within a transparent enclosure of such devices. However, servicing and maintenance of such devices may tedious and cumbersome, as repairs of the light sources and the sensors may require complete disassembly of the transparent enclosure of the device. Also, for performing such disassembly and re-assembling of the device, a skilled operator may be required, thereby increasing costs associated with maintenance and servicing.

The present disclosure is directed to overcome one or more limitations stated above or any other limitation associated with the prior arts.

### SUMMARY

One or more shortcomings of the prior art are overcome by a device as claimed and additional advantages are provided through the device as claimed in the present disclosure. Additional features and advantages are realized through the techniques of the present disclosure. Other embodiments and aspects of the disclosure are described in detail herein and are considered a part of the claimed disclosure.

In an exemplary embodiment of the present disclosure, a device for indicating orientation of an object is disclosed. The device includes a housing mountable on the object. The housing includes a first light source disposed on a first face of the housing and a second light source disposed on a second face of the housing. Further, the housing includes a first screen disposed on a third face of the housing, opposite to the first light source and a second screen disposed on a fourth face of the housing opposite to the second light source. Further, the device includes a hollow spherical member disposed within the housing and a solid sphere provided within the hollow spherical member. The solid sphere is configured to displace within the hollow spherical member pointing towards gravity, the solid sphere is adapted cast a shadow on the first screen and the second screen based on light illuminated from the first light source and the second light source, to indicate orientation of the object.

In an embodiment, the solid sphere displacing within the hollow spherical member pointing towards gravity, blocks the impinging light on a corresponding portion of the first screen and the second screen to cast the shadow on the first screen and the second screen.

In an embodiment, the hollow spherical member is made of a transparent or translucent material to allow impinging light on to the first screen and the second screen.

In an embodiment, the solid sphere is made of an opaque material to block impinging light on to a portion of the first screen and the second screen to cast the shadow.

In an embodiment, the solid sphere makes a point contact with the hollow spherical member.

In an embodiment, the device is configured to determine the orientation of the object in pitch, yaw and roll axes.

In an embodiment, an image capturing unit, the image capturing unit is configured to capture images of the shadow casted on the first screen and the second screen.

In an embodiment, the device includes a computing unit communicatively coupled to the image capturing unit. The computing unit is configured to receive the images captured by the image capturing unit, determine position of the casted shadow on the first screen and the second screen and indicate position of the objection, based on determined positions of the shadow on the first screen and the second screen.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the detailed disclosure. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates sectional view of a device for determining orientation of the object, in accordance with an exemplary-embodiment of the present disclosure.

FIG. 2 illustrates the device of FIG. 1, positioned on an object, which is in an idle condition in accordance to an exemplary embodiment of the present disclosure.

FIG. 3 illustrates device of FIG. 1, positioned on the object, which is oriented at an angle α with respect to horizontal, in accordance to an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE DISCLOSURE

The foregoing has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that, the conception and specific embodiments disclosed may be readily utilized as a basis for modifying other brackets, devices, system, methods and processes for carrying out the same purposes of the present disclosure. It should also be realized by those skilled in the art that, such equivalent construction and method do not depart from the scope of the disclosure as set forth in the appended claims. The novel features which are believed to be characteristics of the disclosure, to its construction and features, together with further objects and advantages will be better understood from the following description when considered in connection with the accompanying figures. It is to be expressly understood, however, that each of the figures is provided for the purpose of illustration and description only and is not intended as a definition of the limits of the present disclosure.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”. “comprising”, or any other variations thereof, are intended to cover a non-exclusive inclusions, such that a device or a system or a method that comprises a list of components or steps does not include only those components or steps but may include other components or steps not expressly listed or inherent to such device, system or method. In other words, one or more elements in a device or a system or a method proceeded by “comprises . . . a” does not, without more constraints, preclude the existence of other elements or additional elements in the device or system or method.

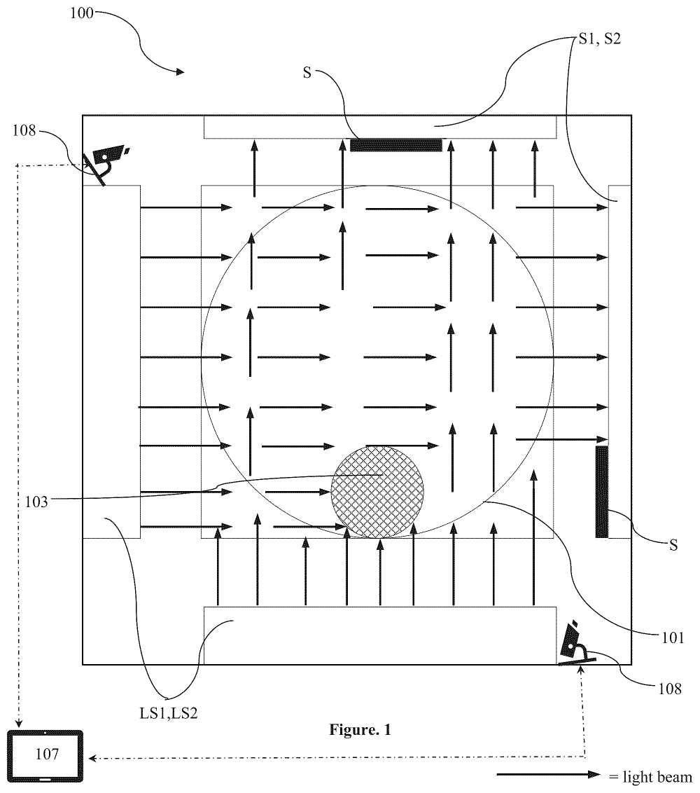

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-3.

FIG. 1, illustrates a front view of a device (100) for determining orientation of an object (200). The device (100) may include a housing which may be mounted on the object. The housing may include a plurality of light sources (LS1, LS2), which may be positioned within the housing (106) or may be positioned at a distance from the housing (106) and are connected to the housing (106) using suitable connecting members such as but not limiting to fasteners. In an embodiment, each of the plurality of light sources (LS1, LS2) may be coupled to the housing (106) or may be positioned inside the housing (106) in vicinity of the spherical member (101). That is, the plurality of light sources (LS1, LS2) may be positioned either of left and bottom, left and top, right and top, right and bottom of the hollow spherical member (101) (thus, the housing (106)). In some embodiments, the plurality of light sources (LS1, LS2) may be positioned inside the housing (106) in vicinity to the hollow spherical member (101). In an illustrated embodiment, the plurality of light sources (LS1, LS2) may include a first light source (LS1) which may be disposed on a first face (F1) of the housing (105) and a second light source (LS2) which may be disposed on a second face (F2) of the housing (105). Furthermore, the device (100) may include a plurality of screens (S1, S2), which may be positioned opposite to each of the plurality of light sources (LS1, LS2) such that, light emitted by the plurality of light sources (LS1, LS2) falls on the plurality of screens (S1, S2). In an illustrated embodiment, the plurality of screens (S1, S2) may include a first screen (S1) disposed on a third face (F3) of the housing (14), opposite to the first light source (LS1) and a second screen (S2) disposed on a fourth face (F4) of the housing (14) opposite to the second light source (LS2). Further, the device (100) may include a hollow spherical member (101) which may be disposed within the housing (106). In an embodiment, the hollow spherical member (101) may be made of transparent or translucent material, which allow light to pass through.

Referring further to FIG. 1, the device (100) may include an solid sphere (103) which may be provided within the hollow spherical member (101). The solid sphere (103) may be configured to displace i.e. roll freely within the hollow spherical member (101) relative to orientation or displacement of the object (200) and may make a point contact with the hollow spherical member (101). In an embodiment, the solid sphere (103) displaces within the hollow spherical member (101) pointing towards gravity i.e. the solid sphere (103) occupies substantially lower most position of the hollow spherical member (101). In an embodiment, the lowermost position of the hollow spherical member (101) continuously vary based on the orientation of the object (200). The solid sphere (103) may roll or revolve within the hollow spherical member (101) and may occupy a lowest most position within the hollow spherical member (101) at that instant of time during orientation of the object (200). In an embodiment, the solid sphere (103) occupying the lowest most position may block impingement of light from each of the plurality of light sources (LS1, LS2), thereby casting a shadow (S) on each of the plurality of screens (S1, S2). Further, as apparent from FIG. 1, the device (100) may include an image capturing unit (108), which may be configured to capture images of each of the plurality of screens (S1, S2). In an embodiment, the image capturing unit (108) may be coupled to the housing (106) by suitable fastening means. As an example, the image capturing unit (108) may be a camera. Further, the device (100) includes a computing unit (107), which may be communicatively coupled to the image capturing unit (108). The computing unit (107) may be configured to receive the images captured by the image capturing unit (108), determine position of the casted shadow on the first screen (S1) and the second screen (S2) and indicate position of the objection, based on determined positions of the shadow on the first screen (S1) and the second screen (S2). In an embodiment, the computing unit (107), may, be programmed to indicate orientation of the object (200) in pitch, roll and yaw axes, based on position of the casted shadow (S) on each of the plurality of screens (S1, S2) in at least one of an analog form and a digital form.

In an embodiment, the solid sphere (103) may be made of heavy material to avoid damping. That is, the during displacement of the solid sphere in response to orientation of the object, the solid sphere of heavy material may occupy the lowermost position in the hollow spherical member (101) without any oscillation motions.

In an embodiment, the solid sphere (103) may be made of an opaque material, to completely block impingement of light on to the plurality of screens (S1, S2), for effective functioning of the device (100).

In an embodiment, the computing unit (107) may be associated with an indication unit [not shown in figures] such as a display to indicate orientation of the object (200) in pitch, yaw and roll axes. The indication unit indicates orientation of the object (200) in at least one of analog form or digital form.

In an embodiment, the housing (106) may facilitate in fastening or positioning the device (100) on an object (200), whose orientation has to be determined. As an example, the housing (106) may assist in fastening the device (100) on to the object (200) via fastening means, such as but not limiting to screw fastening, bolting arrangement and the like.

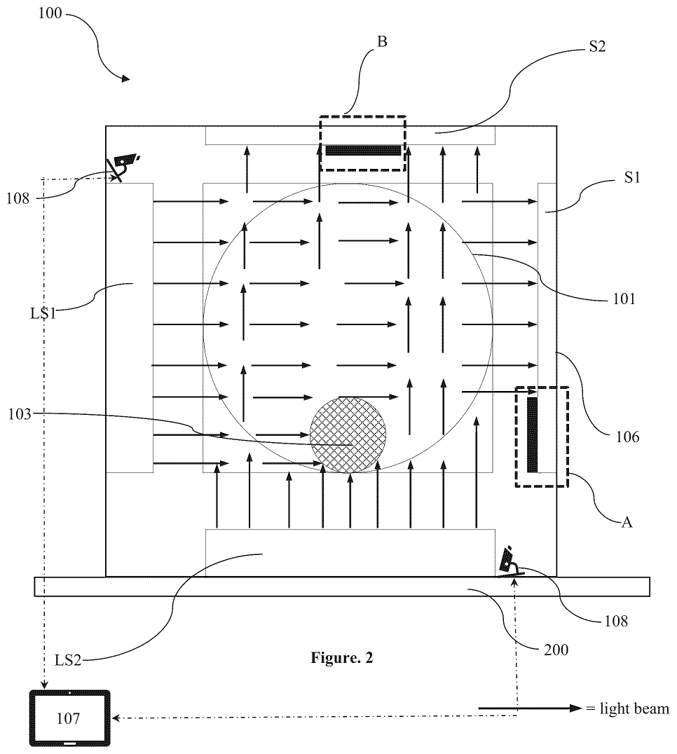

Now referring to FIG. 2 which illustrates the device (100) fixed to the object/platform (200). The object/platform (200) is in an idle condition i.e. the orientation or displacement of the object/platform (200) is zero. In an illustrated embodiment, the device (100) is described in relation to light sources (LS1, LS2) and screens (S1, S2). However, the same cannot be construed as a limitation, since the device (100) may include more than two light sources and the screens. The solid sphere (103) may displace within the hollow spherical member (101), pointing towards gravity and may occupy a lowermost position of the hollow spherical member (101), under the action of gravity. The solid sphere (103) in the lower most position, may block impingement of light from the light sources (LS1, LS2) on to a portion of the screen S1 and S2, thereby casting shadow (S) at portion A on S1 and at portion B on S2. In an embodiment, lowermost position of the hollow spherical member (101) may continuously vary based on the orientation of the object (200). Further, the image capturing unit (108) may continuously capture the images of the screen (S1, S2), where the captured images may be fed into the computational unit, Based on position of the casted shadow (S) in the images captured by the image capturing unit (108), the computing unit (107) may indicate orientation of the object (200), in pitch, roll and yaw axes (i.e. three mutually perpendicular axes), in digital or analog form.

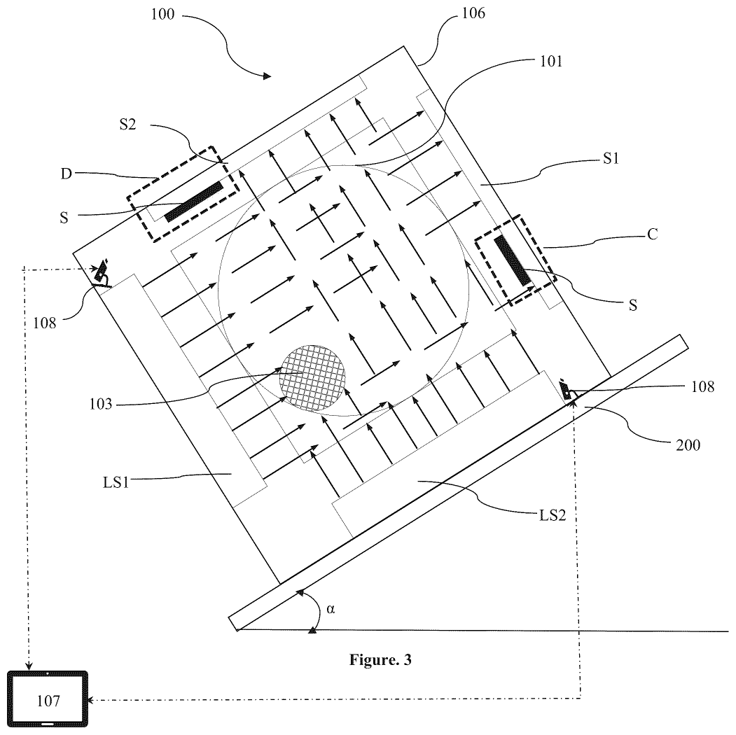

Now referring to FIG. 3, which illustrates the device (100) positioned on the object (200). In an illustrative embodiment, the object/platform (200) is oriented at a certain angle α, with respect to horizontal. Upon orientation of the object/platform (200), the solid sphere (103) may displace or roll or revolve, within the hollow spherical member (101), pointing towards gravity, based on the orientation of the hollow spherical member (101) (thus, the object (200)). Due to effect of gravity, the solid sphere (103) may occupy the lowermost position of the hollow spherical member (101). The solid sphere (103) in the lower most position, may block impingement of light from light sources (LS1, LS2) on to a portion of the screens (S1, S2), thereby casting shadow (S) at portion C on S1 and at portion D on S2. In an embodiment, lowermost position of the hollow spherical member (101) may continuously vary based on the orientation of the object (200). Further, the image capturing unit (108) may continuously capture the images of the screens (S1, S2), where the captured images may be fed into the computational unit. Based on position of the casted shadow (S) in the images captured by the image capturing unit (108), the computing unit (107) may be programmed indicate orientation of the object (200), in pitch, roll and yaw axes (i.e. three mutually perpendicular axes), in digital or analog from.

In an embodiment, the lowermost position of the hollow spherical member (101) may change continuously based on orientation of the object (200). Thus, the solid sphere (103), blocks light from the light sources (LS1, LS2) in the lowermost position of the hollow spherical member (101) at that instant of time, and thus facilitates in determining orientation of object (200).

In an embodiment, the hollow spherical member (101) may be coupled to the housing (105) by a support element (not shown in Figures), which may have minimal or negligible impact on passing of light transmitted by the one or more light sources (LS1, LS2). The support element may be transparent and may be include structure such as but not limited to, a rod, a shaft, a beam and any other structure capable of holding the hollow spherical member (101) within the housing (105).

In an embodiment, the device (100) facilitates in determining orientation of the object (200) about three mutually perpendicular axes i.e. Pitch, Roll and Yaw axes in that position.

In an embodiment, the object (200) may be at least one of automobiles, aircrafts, ships, manufacturing machines and the like.

In an embodiment, the plurality of light sources may be at least a laser beam, candescent light source, and an incandescent light source, which may impinge light onto each of the plurality of screens (S1, S2).

In an embodiment, the housing (106) of the device (100) including the one or more light sources (LS1, LS2), the plurality of screens (S1, S2) and the hollow spherical member (101) may be maintained in vacuum.

In an embodiment, the housing (106), the spherical member (101) and the solid sphere (103) may be made of three-dimension (3D) printing technique.

In an embodiment, the housing (106) may be defined to include transparent/translucent for effectively allowing the light to pass through.

In an embodiment, the device (100) is simple in construction.

In an embodiment, due to simple construction, the device (100) is economical for manufacture.

It should be noted that in an exemplary embodiment, as seen in the FIGS. 1-3 the features, construction, position and connections should not be construed as a limitation as the device (100) may include any other type of features, construction, position, and connections which may work with other combinations for indicating orientation of the object (200).

It should be imperative that the device (100) and any other elements described in the above detailed description should not be considered as a limitation with respect to the figures. Rather, variation to such system and method should be considered within the scope of the detailed description.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations” without other modifiers, typically means at least two recitations, or two or more recitations). Furthermore, in those instances where a convention analogous to “at least one of A, B. and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting, with the true scope.

### REFERRAL NUMERALS

| Description | Referral Numeral |
|---|---|
| Device | 100 |
| Spherical member | 101 |
| Screens | (S1, S2) |
| Solid sphere | 103 |
| Light sources | (LS1, LS2) |
| Housing | 106 |
| Computing unit | 107 |
| Image capturing unit | 108 |
| Object | 200 |

1. A device (100) for indicating orientation of an object (200), the device (100) comprising:
a housing (105) mountable on the object (200), the housing (105) comprises:
a first light source (LS1) disposed on a first face (F1) of the housing (105);
a second light source (LS2) disposed on a second face (F2) of the housing (105);
a first screen (S1) disposed on a third face (F3) of the housing (14), opposite to the first light source (LS1); and
a second screen (S2) disposed on a fourth face (F4) of the housing (14), opposite to the second light source (LS2);
a hollow spherical member (101) disposed within the housing (14); and
a solid sphere (103), provided within the hollow spherical member (101), wherein the solid sphere (103) is configured to displace within the hollow spherical member (101) pointing towards gravity, the solid sphere (103) is adapted cast a shadow on the first screen (S1) and the second screen (S2) based on light illuminated from the first light source and the second light source, to indicate orientation of the object (200) (P).

2. The device (100) as claimed in claim 1, wherein the solid sphere (103) displacing within the hollow spherical member (101) pointing towards gravity, blocks the impinging light on a corresponding portion of the first screen (S1) and the second screen (S2) to cast the shadow on the first screen (S1) and the second screen (S2).

3. The device (100) as claimed in claim 1, wherein the hollow spherical member (101) is made of a transparent or translucent material to allow impinging light on to the first screen (S1) and the second screen (S2).

4. The device (100) as claimed in claim 1, wherein the solid sphere (103) is made of an opaque material to block impinging light on to a portion of the first screen (S1) and the second screen (S2) to cast the shadow.

5. The device (100) as claimed in claim 1, wherein the solid sphere (103) makes a point contact with the hollow spherical member (101).

6. The device (100) as claimed in claim 1, wherein the device (100) is configured to determine the orientation of the object (200) in pitch, yaw and roll axes.

7. The device (100) as claimed in claim 1, comprising an image capturing unit (108), the image capturing unit (108) is configured to capture images of the shadow casted on the first screen (S1) and the second screen (S2).

8. The device (100) as claimed in claim 8, comprising a computing unit (107) communicatively coupled to the image capturing unit (108), the computing unit (107) is configured to:
receive the images captured by the image capturing unit (108),
determine position of the casted shadow on the first screen (S1) and the second screen (S2); and
indicate position of the objection, based on determined positions of the shadow on the first screen (S1) and the second screen (S2).
